(19) United States
(12) Patent Application Publication
(10) Pub. No.: US 2018/0274212 A1
(43) Pub. Date: Sep. 27, 2018

(54) ELECTRIC-CONTROL VALVE FOR CONTROLING FLOW OF FLUID IN A BUILDING INSTALLATION AND DEVICE COMPRISING SUCH AN ELECTRIC-CONTROL VALVE

(71) Applicant: LE SAVOIR INDUSTRIEL, Argenteuil (FR)

(72) Inventor: Pierre KUCHLY, Saint Forget (FR)

(73) Assignee: LE SAVOIR INDUSTRIEL, Argenteuil (FR)

(21) Appl. No.: 15/926,438

(22) Filed: Mar. 20, 2018

(30) Foreign Application Priority Data
Mar. 21, 2017 (FR) 1770277

(51) Int. Cl. E03B 7/07; F16L 55/10; F16K 37/00

(52) U.S. Cl. CPC E03B 7/072; E03B 7/075; G01F 15/003; F16L 55/1022; F16K 37/0041; E03B 7/078

(57) ABSTRACT

An electrovalve for monitor and controlling the fluid supply of an installation of a building, said installation comprising piping in which a fluid circulates, said electrovalve comprising an electrovalve body (2), an inlet (23) to be connected to said piping (10), an outlet (24) also to be connected to said piping (10), a passage (25) provided between said inlet (24) [sic] and said outlet (25) [sic], equipped with sealable closing means (31) movable between an open position, by which the fluid is allowed to circulate in said passage (25) between said inlet (23) and said outlet (24), and a closed position by which the passage (25) is blocked and prohibits any circulation of fluid between said inlet (23) and said outlet (24). The electrovalve comprises a device (4) for controlling the closing means (31) associated with a flowmeter (5). According to the invention, the flowmeter (5) comprises an internal chamber (50) provided in the body of the electrovalve and the electrovalve comprises a secondary fluid passage circuit between the inlet of the chamber and the outlet of the chamber, the inlet and the outlet being connected to the primary fluid passage circuit.

### SUBJECT OF THE INVENTION

The invention concerns the monitoring and operation of a fluid supply system of a building, for example, or of an automatic sprinkling system, or more generally the monitoring and control of a fluid supply, or not, of an installation supplied by fluid.

Moreover, it concerns improvements made in the field of electrovalves and devices equipped with electrovalves, dedicated to monitoring for leaks of fluid (for example water leaks) in piping supplying buildings.

### STATE OF THE ART

Known from the document WO 2016 079353 is an installation for detecting and correcting fluid leaks.

Such an installation includes an electrovalve, capable of cutting off the fluid supply of a system, a flowmeter and a pressure switch. The implementation of the installation involves the operation of the electrovalve with the pressure switch or with the flowmeter, depending on the type of leak detected (small leak or large leak).

Such a technology can enable leaks to be detected and solutions to be provided. However, this installation requires the insertion of a plurality of devices into the fluid system and it can be cumbersome or difficult to install.

As the cause of the invention, the problem is therefore to propose a device that is easy to install, requires little space and enables the detection of leaks in the system.

Known from the document WO 2013/006707 is an electrovalve for monitoring and controlling the fluid supply of an installation of a building, said installation comprising piping in which a fluid circulates, said electrovalve comprising:
An electrovalve body,
An inlet to connect to said piping,
An outlet also to connect to said piping,
A passage provided between said inlet and said outlet, forming a primary fluid passage circuit, equipped with sealable closing means movable between an open position, by which the fluid is allowed to circulate in said passage between said inlet and said outlet, and a closed position by which the passage is blocked and prohibits any circulation of fluid between said inlet and said outlet,
A control device for the closing means,

said electrovalve further comprising a flowmeter capable of acquiring data concerning the flow rate of fluid passing through said electrovalve and capable of transmitting said acquired data to a module external to said electrovalve.

Within the scope of one embodiment presented in this document, the flowmeter is located in the inlet conduit of the valve. The flowmeter thus provides information about the principal flow of circulating fluid. For example, it makes it possible to measure the quantity of flow passing through the valve in order to quantify the consumption of water, for example.

However, the flowmeter does not allow small leaks (microleaks) in the piping to be detected. Thus, if a joint is defective or if a pipe is damaged (but not inoperable), such a valve described in the document WO 2013/006707 will not detect it.

### SUMMARY OF THE INVENTION

The invention seeks to enable the detection of these microleaks. It also seeks to offer a device easy to install in an existing installation, for example on a pipe supplying fluid to a building and which can be associated with other devices or services, for example an application on a smartphone or on a Website, so as to offer a service of controlling the operation of the system automatically or on demand, depending on a variety of predetermined scenarios.

To that end, it proposes, firstly, an electrovalve for monitoring and controlling the fluid supply of an installation of a building, said installation comprising piping in which a fluid circulates, said electrovalve comprising:
An electrovalve body
An inlet to be connected to said piping,
An outlet also to be connected to said piping,
A passage provided between said inlet and said outlet, forming a primary fluid passage circuit, equipped with sealable closing means, which is movable between an open position, by which the fluid is allowed to circulate in said passage between said inlet and said outlet, and a closed position by which the passage is blocked and prohibits any circulation of fluid between said inlet and said outlet,
A device for controlling the closing means.

The electrovalve according to the invention further comprises a flowmeter capable of acquiring data concerning the rate of flow of fluid passing through said electrovalve and capable of transmitting said acquired data to a module external to said electrovalve.

The electrovalve according to the invention is notable in that the flowmeter comprises a chamber provided in the body of the electrovalve, said chamber further comprising a chamber inlet and a chamber outlet that are connected to said primary fluid passage circuit in the electrovalve, a secondary fluid passage circuit being defined between said chamber inlet and said chamber outlet.

The electrovalve thus produced constitutes a device that combines a plurality of functions: control of the closing or opening of the fluid passage, and control of a flow rate of fluid in the fluid system in which the electrovalve according to the invention can be installed.

Thus, the device is compact and easy to install in an existing system, in the same way as one would install a known conventional electrovalve.

The presence of the chamber, in which the flowmeter is positioned, and of the secondary circuit makes it possible to detect microleaks undetected by flowmeters of electrovalves that are placed directly in the inlet or outlet conduits.

According to one embodiment of the electrovalve according to the invention, the data acquired and transmitted can be electrical pulses.

Again, according to one embodiment of the electrovalve according to the invention, the chamber of the flowmeter can include:
a. A blade turbine, mounted in free rotation around its axis, and
b. A detection cell placed near the blades of said turbine.

Secondly, the invention seeks to propose a device for monitoring and controlling a fluid supply system of an installation, the device comprising:
An electrovalve as defined above,
A module for reception and processing of data transmitted by the flowmeter, said module for reception and processing of data being capable of transmitting orders to the device for controlling the closing means and of generating and transmitting information to a user apparatus external to the device via an information broadcast network, and
An energy supply device capable of receiving an energy source in order to supply the module for reception and processing of data, the flowmeter and the device for controlling the closing means.

The device according to the invention can comprise a housing that in particular accommodates said electrovalve, said module for reception and processing of data and said energy supply device. Within the scope of this embodiment, said housing further comprises a housing inlet designed to allow passage to the inlet of said electrovalve and a housing outlet designed to allow passage to the outlet of the electrovalve.

According to one advantageous embodiment of the device according to the invention, the module for reception and processing of data comprises an electronic card designed to analyze the data furnished by the flowmeter, and to generate and transmit information signals to said user apparatus.

Again, according to one embodiment of the device according to the invention, the electronic card is designed to receive and analyze data transmitted by said user apparatus and to control an action of the electrovalve in response to the data received via the device for controlling the means of closing the electrovalve.

Advantageously, the module for reception and processing of data transmits information signals via BPL, Bluetooth, Wi-Fi or radio waves.

Finally, the invention concerns an assembly comprising a device such as the one defined above and an apparatus capable of receiving information and/or of transmitting information to the module for reception and processing of data from said device.

Within the scope of one embodiment of the assembly according to the invention, the apparatus is capable of controlling operation scenarios of said device.

### BRIEF DESCRIPTION OF THE FIGURES

In order to be executed, the invention is explained sufficiently clearly and completely in the following description, which is accompanied by drawings in which:

FIG. 1 is a perspective view of an electrovalve according to the invention,

FIG. 2 is a side view of the electrovalve shown in FIG. 1,

FIG. 3 is a top view of the electrovalve shown in FIGS. 1 and 2,

FIG. 5 is a perspective view of a device according to the invention,

FIG. 6 is another perspective view of the device shown in FIG. 5,

FIG. 7 is again another perspective view of the device shown in FIGS. 5 and 6, one wall of which has been removed and the remaining walls being illustrated transparently in order to show the contents of the device,

FIG. 8 is a front view of the device shown in FIG. 7,

FIG. 9 is another perspective view of the device according to the invention, the walls of the device being represented transparently, the figure illustrating the rear of the device and the elements of which it is comprised,

FIG. 10 is again another perspective view of the device, the side walls of the device having been removed (except for the rear wall),

FIG. 11 shows an assembly according to the invention, comprising a device represented in perspective and installed on a pipe, as well as an apparatus represented schematically, held in the hand of a user.

### DETAILED DESCRIPTION OF ONE EMBODIMENT

In the following description, the terms “lower,” “upper,” “top,” “bottom,” etc. are used with reference to the drawings to facilitate comprehension. They should not be understood as being limitations to the scope of the invention, particularly with respect to the orientation of the elements of which the device is comprised, for example.

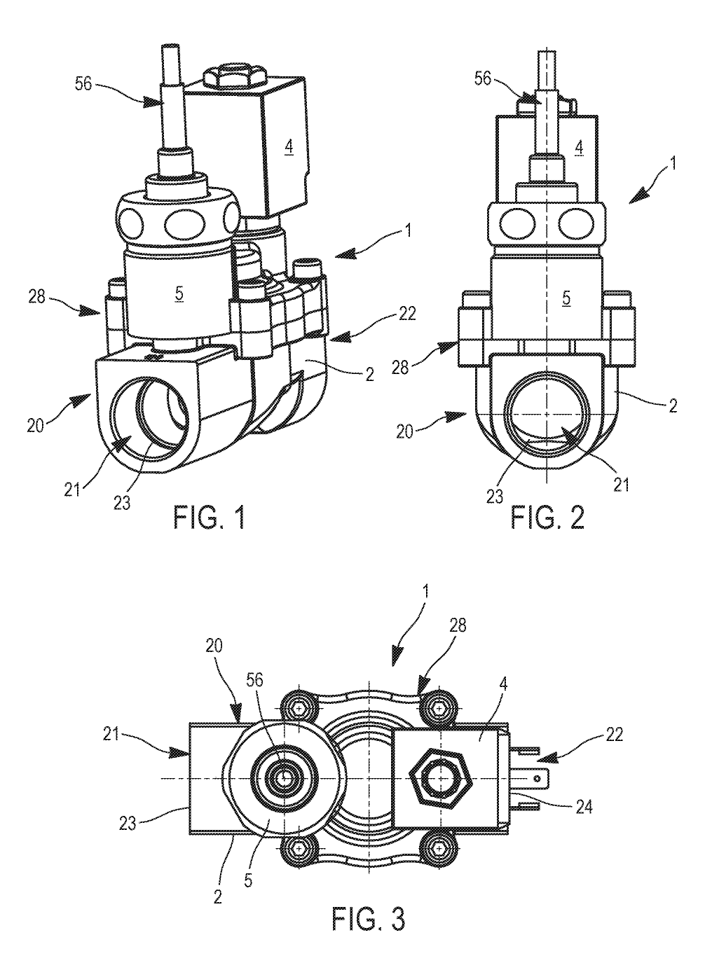

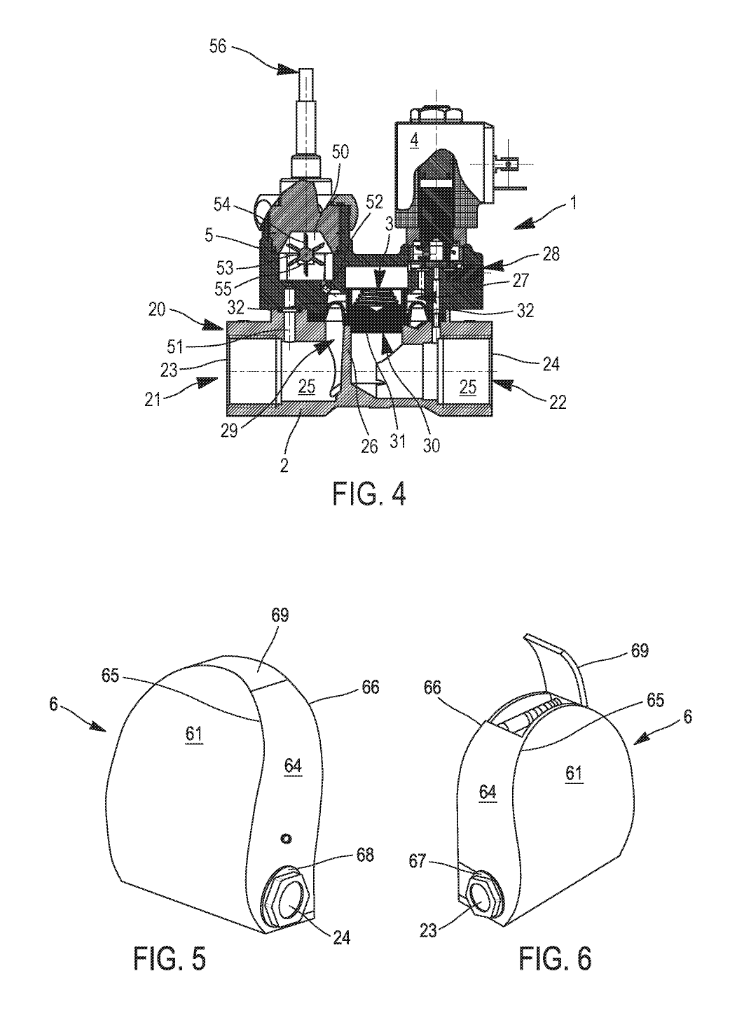

Firstly, reference will be made to FIGS. 1 to 4 to describe the electrovalve according to the invention. Secondly, reference will be made to the device according to the invention including the electrovalve described in FIGS. 1 to 4.

The electrovalve described is illustrated is [sic] a differential control or membrane-assisted electrovalve: the membrane-assisted electrovalve functions by a control coil that ensures the opening or closing of the electrovalve by transmission of signals.

The electrovalve 1 shown in the figures conventionally comprises an electrovalve body 2 produced from a material capable of withstanding high internal pressures.

The body 2 comprises a lower, substantially longitudinal hollow part 20, open at both ends 21 and 22 thereof. The opening of the end 21 constitutes an inlet 23 of the electrovalve 1, to be connected to a water inlet pipe, for example (water or any other fluid), and the opening of the end 22 constitutes an outlet 24 of the electrovalve 1, also to be connected to the pipe. In other words, the electrovalve is installed on a water inlet pipe (in our example) by connecting its inlet 23 and its outlet 24 to the pipe in such a way that the water under pressure in the pipe enters the electrovalve by the inlet 23 and leaves the electrovalve by the outlet 24.

A passage 25 is thus provided between the inlet 23 and the outlet 24 of the portion 1 of the electrovalve and forms what will be called hereinafter a primary fluid passage circuit (see FIG. 4).

As can be [sic], the hollow lower part 20 comprises a transverse inner wall 26 that stands substantially midway between the inlet 23 and the outlet 24, forming an obstacle inside the passage 25.

Said obstacle constitutes a deflecting wall that orients the fluid entering the passage 25 of the electrovalve 1 towards an internal chamber 27 provided in a second portion (or upper portion) 28 of the body 2 (see FIG. 4).

The electrovalve 1 thus comprises a second passage 29 allowing the inlet of fluid into the chamber 27. It also comprises a third passage 30 that allows the outlet of the fluid from the chamber towards the passage 25 downstream from the wall 26, towards the outlet 24 of the electrovalve 1.

The passage 30 can be closed or open so as to prevent or allow the circulation of fluid between the inlet 23 and the outlet 24 of the electrovalve. To do this, the chamber 27 comprises sealable closing means 3, which are movable between a first position, called open, in which the fluid is allowed to circulate and rejoin the passage 25, and a second position, called closed, into which the passage 30 is blocked, also blocking the passage 25 so that any circulation of fluid is impossible between the inlet 23 and the outlet 24 of the electrovalve 1 (see FIG. 4).

The sealable closing means 3 are produced by a flap 31, which comprises a flexible peripheral membrane 32, secured between the lower portion 20 and the upper portion 28 of the body of the electrovalve. The flap 31 is mounted movably between a closed position (shown in FIG. 4) in which it closes the passage 30, and an open position in which the flap rises in the chamber 27 and frees the passage 30 (position not shown).

The flap 31 is held in closed position particularly by a coil system.

When the flap is in the closed position, it is said that the electrovalve is closed, and when the flap is in the open position, it is said that the electrovalve is open.

To allow the change of the flap 31 from its closed position to its open position, the electrovalve comprises a control device 4, as is known per se.

The control device 4 is electrically supplied in order to function. Details of the operation of this type of control device will not be described here, being known to a person skilled in the art, and not being necessary to the comprehension of the invention.

According to the invention, the electrovalve 1 comprises a flowmeter 5 (or flow detector 5).

The flowmeter 5 and the control device are both associated with the upper portion 28 of the body 2 of the electrovalve. The flowmeter 5 is incorporated into the upper portion 28 of the body 2.

FIG. 4 shows this arrangement: the flowmeter comprises a chamber, constituting a second internal chamber 50 provided in the upper portion of the body 2. The chamber 50 comprises a chamber inlet 51 through which the fluid enters, and a chamber outlet 52 through which the fluid leaves.

The chamber inlet 51 and the chamber outlet 52 both open into the primary fluid passage circuit, i.e., into the passage 25. Thus, it can be considered that the circuit used by the fluid entering the chamber 50 and leaving the chamber is a secondary fluid passage circuit. Said secondary fluid passage circuit makes it possible to isolate a part of the flow passing through the electrovalve: said isolation is what makes it possible to detect microleaks in the piping.

The chamber 50 of the flowmeter 5 comprises a turbine 53, mounted in free rotation around its axis, and comprising six blades 54.

The chamber 50 also comprises a detection cell 55, placed near the blades 54 of the turbine, which makes it possible to detect the passage of a blade in front thereof. Thus, when the turbine 53 makes a complete turn, the detection cell counts six blade passages.

Each passage of a blade in front of the cell 55 is then transformed into an electrical pulse, which can then be transmitted in the form of a signal to an exterior analysis module/device, for example, by means of a cable 56.

The flowmeter 5 is thus capable of acquiring data concerning the flow rate of the fluid passing through the electrovalve 1, and in particular the flow rate of the secondary flow extracted from the primary flow, and capable of transmitting these data acquired from the secondary flow to a module external to the electrovalve.

It is understandable from the foregoing how the electrovalve according to the invention enables, at the same time, the fluid supply of an installation to be controlled, by closing or opening the electrovalve 1 by the device 4 for controlling the means 30 of closing the primary passage circuit 25 of the fluid.

It is also understandable how the invention makes it possible to monitor the fluid supply of an installation by the integrated flowmeter 5 and secondary fluid passage circuit.

Produced in this way, the electrovalve 1 constitutes a compact device that is integrated into a plumbing installation as easily as a conventional electrovalve, without taking up more space than a conventional electrovalve.

A device according to the invention will now be described that integrates such an electrovalve and that makes it possible to offer services to a user, particularly to warn the user of a leak, and to remotely or automatically control the closing or opening of the electrovalve.

The device according to the invention is referenced 6 in the figures.

The function thereof is to allow a remote user to be informed of the condition of his system and/or to control it remotely by triggering various scenarios. The device 6 is programmable according to the schedule of the user, or activatable from time to time by a smartphone, tablet, computer, etc.

In particular, the user can be a hotel operator, a community, etc., and the device can be installed on a pipe of any system and for any type of fluid.

The device 6 is activatable whenever the user so wishes, or in response to a signal, or when an intrinsic program is triggered. The device communicates with the apparatus of the user via BPL, Bluetooth, radio waves, Wi-Fi or any other known means of transmitting information.

The first device 6, presented by way of example, comprises a housing 60 that encloses all the pertinent elements of the device according to the invention, and is connected directly to a pipe. Produced in this way, the housing is easy to handle and install, since it is connected conventionally.

The housing 60 comprises two substantially parallel lateral walls (front wall 61 and rear wall 62), a bottom wall 63 and an edge wall 64 connecting the two free sections 65 and 66 of the two front 61 and rear 62 lateral walls. The edge wall 64 follows a curved shape that is defined by the curved shape of the free sections 65 and 66 of the lateral walls 61 and 62.

According to the invention, the housing 60 comprises an inlet 67 provided by an opening passing through the edge wall 64, near the bottom wall 63. The housing 60 also comprises an outlet 68 also provided by an opening passing through the edge wall 64, opposite to the opening providing the inlet 67 and near the bottom wall 63.

The inlet 67 of the housing 60 is designed to accommodate the inlet 23 of the electrovalve, and the outlet 68 of the housing 60 is designed to accommodate the outlet 24 of the electrovalve. The inlet 67 and the outlet 68 therefore provide passage (give access) to the inlet 23 and outlet 24 of the electro valve.

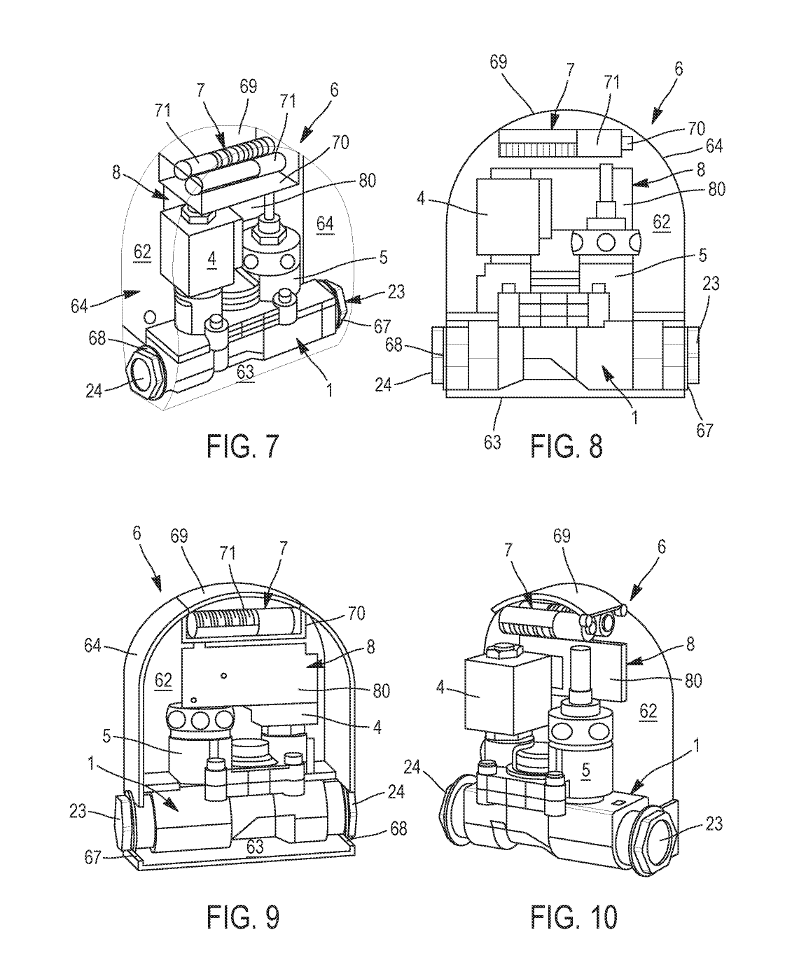

The housing therefore comprises the electrovalve described above and shown in FIGS. 1 to 4. As can be seen in FIGS. 7 to 10, the electrovalve 1 rests on the bottom 63 of the housing.

The control device 4 and the flowmeter 5 are both supplied with energy (indirectly) by an energy source 7 included in the monitoring device 6.

Within the scope of this embodiment, the energy source 7 is provided by two batteries 71 received in a recess 70 provided in the housing of the device. The recess 70 includes connection terminals for the batteries 71, and the assembly constitutes an energy supply device for the monitoring device according to the invention.

Access to the recess 70 to insert or remove the batteries 71 is by a hatch 69, which is achieved by cutting a portion of edge wall 64 in the upper region of the housing 60. FIG. 6 in particular shows the hatch in the open position.

The hatch 69 is mounted pivotably around one of the sides thereof by a hinge that connects it to the edge wall 64.

According to the invention, the energy supply device (70, 71) supplies a module 8 for reception and processing of data to which the flowmeter 5 and the control device 4 are connected (the module 8 is visible in FIGS. 7 to 10).

The module 8 can be achieved specifically in different ways: within the scope of this embodiment, it includes an electronic card 80 that enables data to be received and analyzed, generating new data and transmitting them to a user apparatus 9 external to the device 6, in the form of information signals 90 via a variety of broadcast networks such as Wi-Fi, Bluetooth, various radio waves, etc.

The electronic card 80 can also receive information signals 91 originating from outside the housing 60, analyze them and control an action of the electrovalve in response to the signals 91, by transmitting orders to the device 4 for controlling the means of closing the electrovalve.

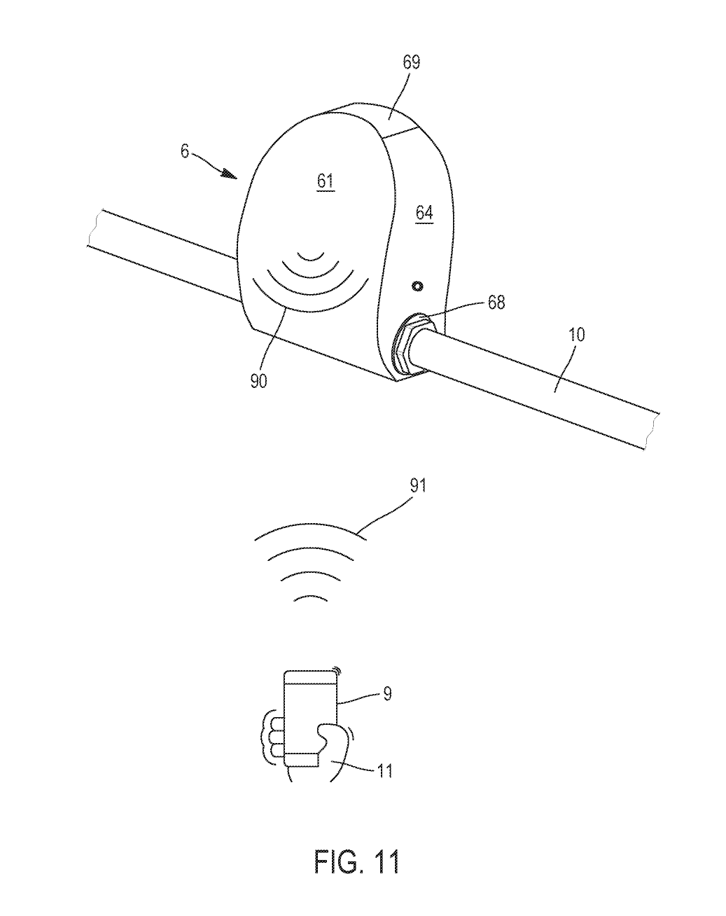

Reference is now made to FIG. 11 to explain one mode of operation of an assembly according to the invention that would comprise a device 6 according to the invention, as described above and represented in FIGS. 7 to 10, as well as a user apparatus 9 external to the device.

Within the scope of this example, the device 6 is installed on a water inlet pipe 10 of the home of a user (illustrated schematically by the hand 11 in FIG. 11).

The user apparatus 9 is capable of implementing a computer application, dedicated to the operation of the device 6.

The user apparatus is for example a smartphone, as illustrated in FIG. 11. The smartphone is capable of receiving information 90 and transmitting information 91 to the module 8 for reception and processing of data from said device 6.

A water leak is identified by the monitoring device 6 following the processing of the pulse data transmitted by the flowmeter 5 to the module 8.

The module 8 then sends a signal 90 to the user apparatus 9, which then informs the user of the presence of a leak in the supply system of his home.

The user apparatus 9 also indicates to the user that the water supply system of his home has been cut off. Indeed, in the present scenario, the detection of the water leak by the module 8 has triggered the closure of the electrovalve 1 because the module 8, in addition to transmitting the signal 90, has transmitted to the control device 4 an operation order: close the flap 31.

The user is then requested, via the application on his smartphone 9, to contact a plumber.

The module 8 can also have sent a signal to another apparatus with which a plumber is equipped, to order service by the plumber.

It is understandable from the foregoing how the invention makes it possible to monitor the state of operation of a fluid supply system of an installation, whether it is a domestic plumbing installation or another installation that would include piping through which fluid passes that supplies the installation.

However, it should be understood that the invention is not limited to the embodiments specifically represented in the figures, and that it extends to the implementation of any equivalent means.

For example, the monitoring and control device 6 could have another form and the module 8 could be achieved differently: it could comprise technical means other than those described, producing the same technical functions, without going beyond the scope of the invention.

Also, within the scope of the assembly according to the invention, the user apparatus 11 could be different: it could involve a housing dedicated to the operation of the monitoring device and capable of communicating therewith via BPL, Bluetooth, radio waves, etc.

The apparatus would be programmed to implement a plurality of scenarios depending on the information that would be transmitted to it by the monitoring device 6. For example, it could be envisaged that the user apparatus could control the management of fluid flows of an installation, control a mode of operation of the electrovalve according to certain timeslots (in the context of an automatic garden watering system, for example), record data in a history file, indicate to the user his water consumption, etc.

The monitoring device 6 could also be equipped with an audible alarm, or it could transmit information to the apparatus about the consumption level of the batteries 71.

The device according to the invention is of particular interest for plumbing professionals, distributors of domestic appliances, individuals and professionals whose activity requires the implementation of an installation in which fluid circulates (such as gardeners, farmers, communities).

What is claimed:

1. An electrovalve (1) for monitoring and controlling the fluid supply of an installation of a building, said installation comprising piping (10) in which a fluid circulates, said electrovalve comprising:
An electrovalve body (2),
An inlet (23) to be connected to said piping (10),
An outlet (24) also to be connected to said piping (10),
A passage (25) provided between said inlet (24) [sic] and said outlet (25) [sic], forming a primary fluid passage circuit, equipped with sealable closing means (31), which is movable between an open position, by which the fluid is allowed to circulate in said passage (25) between said inlet (23) and said outlet (24), and a closed position by which the passage (25) is blocked and prohibits any circulation of fluid between said inlet (23)and said outlet (24),
A device (4) for controlling the closing means (31), said electrovalve further comprising a flowmeter (5) capable of acquiring data concerning the rate of flow of fluid passing through said electrovalve and capable of transmitting said acquired data to a module (8) external to said electrovalve,
wherein the flowmeter (5) comprises a chamber (50) provided in the body (2) of the electrovalve (1), said chamber (50) further comprising a chamber inlet (51) and a chamber outlet (52) that are connected to said primary fluid passage circuit in the electrovalve (1), a secondary fluid passage circuit being defined between said chamber inlet (51) and said chamber outlet (52).

2. The electrovalve (1) according to claim 1, wherein the data acquired and transmitted are electrical pulses.

3. The electrovalve (1) according to claim 1, wherein said chamber (50) includes:
a. A turbine (53) with blades (54), mounted in free rotation around its axis, and
b. A detection cell (55) placed near the blades (54) of said turbine (53).

4. A device (6) for monitoring and controlling a fluid supply system of an installation, the device comprising:
An electrovalve (1) according to claim 1,
A module (8) for reception and processing of data transmitted by the flowmeter (5), said module (8) for reception and processing of data being capable of transmitting orders to the device (4) for controlling the closing means (31) and of generating and transmitting information (90) to a user apparatus (9) external to the device (6) via an information broadcast network.
An energy supply device (7) capable of receiving an energy source (71) in order to supply the module (8) for reception and processing of data, the flowmeter (5) and the device (4) for controlling the closing means (31).

5. The device (6) according to claim 4, comprising a housing (60) wherein said electrovalve (1), said module (8) for reception and processing of data and said energy supply device (7) are accommodated, said housing (60) further comprising a housing inlet (67) designed to allow passage to the inlet (23) of said electrovalve and a housing outlet (68) designed to allow passage to the outlet (24) of the electrovalve.

6. The device (6) according to claim 4, wherein the module (8) for reception and processing of data comprises an electronic card (80) designed to analyze the data furnished by the flow meter (5), and to generate and transmit information signals (90) to said user apparatus (9).

7. The device (6) according to claim 6, wherein the electronic card (80) is designed to receive and analyze data (91) transmitted by said user apparatus (9) and to control an action of the electrovalve in response to the data (91) received via the device (4) for controlling the means (31) of closing the electrovalve (1).

8. The device (6) according to claim 6, wherein the module (8) for reception and processing of data transmits information signals (90) via BPL, Bluetooth, Wi-Fi or radio waves.

9. Assembly comprising a device (6) according to claim 4 and an apparatus (9) capable of receiving information (90) and/or of transmitting information (91) to the module (8) for reception and processing of data from said device (6).

10. Assembly according to claim 9, wherein the apparatus (9) is capable of controlling operation scenarios of said device (6).
